(19) United States
(12) Patent Application Publication
(10) Pub. No.: US 2026/0340635 A1
(43) Pub. Date: Oct. 29, 2026

(54) METHOD AND SYSTEM FOR CUSTOMER IDENTITY AUTHENTICATION IN FINANCIAL INDUSTRY

(71) Applicant: EARLY SPRING IDENTITY TECHNOLOGY CO., LIMITED, Sai Ying Pun (HK)

(72) Inventor: Yu Haoming, Sai Ying Pun (HK)

(21) Appl. No.: 19/192,433

(22) Filed: Apr. 29, 2025

(51) Int. Cl. G06Q 20/40; G06Q 20/38; G06V 10/75; G06V 20/40; G06V 40/12; G06V 40/16; G06V 40/40; G06V 40/70

(52) U.S. Cl. CPC G06Q 20/40145; G06Q 20/385; G06Q 20/4012; G06Q 20/4015; G06Q 20/4016; G06V 10/751; G06V 20/46; G06V 40/1347; G06V 40/1365; G06V 40/172; G06V 40/40; G06V 40/70

(57) ABSTRACT

Disclosed are a method and system for customer identity authentication in the financial industry, pertaining to the field of identity verification technology and enhancing account and transaction security through multi-layered security protection. First, preliminary authentication ensures that a user passes basic identity verification during login by collecting an OTP, a PIN code, and a security question answer. Second, geolocation verification checks whether the current user location matches historical frequently-used locations, preventing geographically anomalous login risks. Fingerprint recognition further authenticates user identity by analyzing features of core points and peripheral regions. Upon detecting an anomalous behavior, the system triggers an alert and additional verification, mitigating fraud risks. For high-value transactions, the system initiates a pop-up window for user fingerprint authentication and performs further verification if the fingerprint authentication fails, ensuring transaction security. Additionally, social engineering verification validates user identity through video calls, adding an extra layer of security.

### TECHNICAL FIELD

The present invention relates to the field of identity verification technology, and in particular to a method and system for customer identity authentication in the financial industry.

### BACKGROUND

In the financial industry, customer identity authentication is a critical process to ensure transaction security and prevent fraudulent behaviors. Conventional customer identity authentication methods typically rely on single identify verification means, for example, passwords, personal identification number (PIN) codes, one-time passwords (OTPs), etc. These methods suffer from some shortcomings as follows.

Passwords and PIN codes are vulnerable to acquisition by hackers through phishing attacks, brute force cracking, or social engineering, posing high security risks. Modern financial fraud behaviors have grown increasingly sophisticated, and single identify verification means struggle to effectively counter diverse attack methods, such as session hijacking, device information theft, or identity forgery in transactions.

### SUMMARY

In view of the deficiencies in the prior art, the present invention provides a method and system for customer identity authentication in the financial industry to address the problem mentioned in the background section.

To achieve the above objective, the present invention is implemented through the following technical scheme: a system for customer identity authentication in the financial industry, including:
a first collection module configured to collect a one-time password (OTP), a personal identification number (PIN) code, and security question answer information for user login, establish a knowledge factor collection dataset, and match the knowledge factor collection dataset with corresponding values in a database, and if all three items are successfully matched, add a first authentication tag; or if any item fails to match, send a first alert instruction;
a second collection module configured to set up geolocation verification when the user initiates a transaction behavior to obtain a current user geolocation and geofencing status, collect user historical frequently-used locations, and construct a location verification index Dzy, and if the location verification index Dzy is greater than a distance threshold, trigger a second alert instruction; or if the location verification index is less than or equal to the distance threshold, add a second authentication tag;
a third collection module configured to collect a user fingerprint to obtain a fingerprint image, extract user fingerprint-related features to calculate and obtain a core point region distribution index Hxz and a peripheral region distribution index Wwz, correlate the core point region distribution index Hxz and the peripheral region distribution index Wwz, and perform deep computation to obtain a fingerprint factor matching index Zwyz, and if the fingerprint factor matching index Zwyz is below a matching threshold, trigger a third alert instruction; or if the fingerprint factor matching index Zwyz is greater than or equal to the matching threshold, add a third authentication tag;
a verification module configured to, after the user obtains the first authentication tag, allow the user to log into a financial APP to perform inquiry or information retrieval operations; after the user obtains the second authentication tag, allow the user to perform a transaction behavior operation, if a collected transaction behavior exceeds CNY 10,000, trigger a pop-up window to verify the user fingerprint, and after passing the third authentication tag, allow a high-value transaction operation, upon receiving the first alert instruction, the second alert instruction, or the third alert instruction, repeatedly perform the same verification method on the user, and if verification fails three consecutive times, lock an account and require the user to provide original identity documents at an offline service counter for reactivation;
a user behavior recognition module configured to, during the user login and transaction processes, collect user behavior data, establish and train a risk prediction model, and extract device-changing login features, transaction volume behavior features, typing habit features, and account modification information features from the user behavior data to construct an anomalous-behavior index Ycx, and if the anomalous-behavior index Ycx is higher than a behavioral anomaly threshold, send a fourth alert instruction; and
a social engineering dynamic re-verification module configured to, upon receiving the fourth alert instruction, initiate a video call via a management terminal to perform identity verification, and validate identity information and documents of the user, and upon successful authentication, add a fourth authentication tag and allow continued operations.

Preferably, the second collection module includes a geolocation collection unit, a location verification calculation unit, and a location evaluation unit, where
the geolocation collection unit is configured to collect and obtain the current user geolocation through GPS and Internet Protocol (IP)-based geolocation technology, retrieve historical transaction locations, and establish a user frequently-used location database; and
the location verification calculation unit is configured to extract latitude and longitude features of locations from the frequently-used location database, and calculate and obtain the location verification index Dzy through a Haversine formula:

Dzy=2r*a sin(\sqrt{hav(φ₂−φ₁)+cos(φ₁)*cos(φ₂)*hav(λ₂−λ₁)});
where r represents the radius of the Earth, which is set to a value of 6,371 kilometers, φ₁ represents the latitude of a historical location, φ₂ represents the latitude of a current login location, λ₂ represents the longitude of the current login location, λ₁ represents the longitude value of the historical location, hav represents a haversine function; and a sin represents a precision dimension conversion function.represents the precision dimension conversion function.

Preferably, the location evaluation unit is configured to preset a distance threshold, and compare the distance threshold with the location verification index Dzy to obtain a distance evaluation result, including:
if the location verification index Dzy is greater than the distance threshold, it indicates that current user location credibility and geofencing compliance are anomalous with a risk of geographically anomalous login, then the second alert instruction is triggered; or
if the location verification index Dzy is less than or equal to the distance threshold, it indicates that current user location credibility and geofencing compliance are normal without a risk of geographically anomalous login, then the second authentication tag is added.

Preferably, the third collection module includes a fingerprint collection unit, a first feature extraction unit, and a first calculation unit, where
the fingerprint collection unit is configured to collect and obtain the user fingerprint image using an online or offline fingerprint collection device, and perform grayscale processing, binarization, and denoising preprocessing operations on the fingerprint image; and
the first feature extraction unit is configured to extract core point region distribution features and peripheral region distribution features from the preprocessed fingerprint image using the Harris corner detection algorithm, and perform in-depth analysis via the first calculation unit based on the core point region distribution features and the peripheral region distribution features, and calculate and obtain the core point region distribution index Hxz and the peripheral region distribution index Wwz through the following formulas:

$$Zwyz = \frac{{\sum }_{i = 1}^{{N}_{h}} {w}_{i} * ( {D}_{i} + {F}_{i} + {S}_{i} + {A}_{i} ) * ( 1 - \frac{{oD}_{h}}{µ {D}_{h}} ) * ( 1 - \frac{o {θ}_{h}}{µ {θ}_{h}} )}{{A}_{h} * ρ h} ;$$

where Nₕ is the number of feature points in the core point region, wᵢ is the weight of an i-th core point, Dᵢ is the distance between the i-th core point and its nearest neighbor core point; Fᵢ is a bifurcation parameter of the i-th core point; Sᵢ is a short ridge parameter of the i-th core point; A; is an island point parameter of the i-th core point; oDₕ is a standard deviation of distances between all feature points in the core point region; μDₕ is an average value of distances between all feature points in the core point region; oθₕ is a standard deviation of directional angles of all feature points in the core point region; μθₕ is an average value of directional angles of all feature points in the core point region; Aₕ is the area of the core point region; and ρh is a ridge density of the core point region; and

$$Wwz = \frac{{\sum }_{i = 1}^{{N}_{w}} {E}_{i} * ( {C}_{i} + {O}_{i} + {P}_{i} + {R}_{i} ) * ( 1 - \frac{{oD}_{w}}{µ {D}_{w}} ) * ( 1 - \frac{o {θ}_{w}}{µ {θ}_{w}} )}{{A}_{w} * ρ w} ;$$

where N_{w} is the number of feature points in the peripheral region, Eᵢ is the weight of an i-th peripheral feature point, Cᵢ is the distance between the i-th peripheral feature point and its nearest neighbor peripheral feature point; Oᵢ is a bifurcation parameter of the i-th peripheral feature point; Pᵢ is a short ridge parameter of the i-th peripheral feature point; Rᵢ is an island point parameter of the i-th peripheral feature point; oD_{w} is a standard deviation of distances between all feature points in the peripheral region; μD_{w} is an average value of distances between all feature points in the peripheral region; oθ_{w} is a standard deviation of directional angles of all feature points in the peripheral region; μθ_{w} is an average value of directional angles of all feature points in the peripheral region; A_{w} is the area of the peripheral region; and pw is a ridge density of the peripheral region.

Preferably, the third collection module further includes a correlation unit and a fingerprint evaluation unit, where the correlation unit is configured to calculate and obtain the fingerprint factor matching index Zwyz based on the core point region distribution index Hxz and the peripheral region distribution index Wwz through the following correlation formula:

Zwyz=Hxz*α+Wwz*β;
where α and β represent weight coefficients of the core point region distribution index Hxz and the peripheral region distribution index Wwz, respectively, and α+β=1.

Preferably, the fingerprint evaluation unit is configured to construct a matching threshold based on an initial fingerprint recorded by a user in a database and compare the matching threshold with the fingerprint factor matching index Zwyz to obtain a fingerprint matching evaluation result, including:
if the fingerprint factor matching index Zwyz is greater than or equal to the matching threshold, it indicates that a current user fingerprint matching degree is qualified and indicates an operation by the user themselves, the third authentication tag is added; or
if the fingerprint factor matching index Zwyz is less than the matching threshold, it indicates that the current user fingerprint matching degree is anomalous with a risk of unauthorized use, then the third alert instruction is triggered.

Preferably, the user behavior recognition module includes a user behavior data collection unit, a second feature extraction unit, and an anomalous-behavior calculation unit, where
the user behavior data collection unit is configured to record device information used during the user login, including device type, operating system, browser type, and device ID; record transaction behavior data of the user, including transaction amount, transaction frequency, and transaction time; record a typing speed, a keystroke error rate, and a keystroke rhythm of the user; and record modification behaviors by the user on account information, including password modification, contact information modification, and bound device modification;
the second feature extraction unit is configured to, after establishing and training the risk prediction model using machine learning algorithms including logistic regression, decision tree, or random forest, extract the device-changing login features, the transaction volume behavior features, the typing habit features, and the account modification information features from the user behavior data; and
the anomalous-behavior calculation unit is configured to calculate the anomalous-behavior index Ycx of the user in real-time based on the risk prediction model, where the anomalous-behavior index Ycx is calculated and obtained through the following formula:

$$Ycx = \frac{{E}_{f} * {a}_{1} + {T}_{f} * {a}_{2} + {A}_{f} * {a}_{3}}{{a}_{1} + {a}_{2} + {a}_{3}} + ( \frac{{K}_{s}}{{K}_{e}} ) * {a}_{4} + {C}_{1} ;$$

where E_{f} is the value of frequency of device changing by the user, T_{f} is a daily transaction frequency value, A_{f} is a user change frequency value, Kₛ is a typing speed per minute of the user, Kₑ represents an error rate per minute, a₁ [symbol] a₂ [symbol] a₃ and a₄ are all weight coefficients, and C₁ represents a first correction constant.

Preferably, the user behavior recognition module further includes a behavior evaluation unit, where
the behavior evaluation unit is configured to preset the behavioral anomaly threshold and compare the behavioral anomaly threshold with the anomalous-behavior index Ycx for evaluation to obtain a user behavior evaluation result, including:
if the anomalous-behavior index Ycx is greater than the behavioral anomaly threshold, it indicates that an operational behavior of the user has risks, then the fourth alert instruction is sent; or if the anomalous-behavior index Ycx is less than or equal to the behavioral anomaly threshold, it indicates that an operational behavior of the user has no risks.

Preferably, the social engineering dynamic re-verification module performs the following steps:
upon receiving the fourth alert instruction, the system sends a video call request to the user, requiring the user to undergo identity verification through a video call, with content of the request including a video call link and a verification time window;
the user accepts the video call request within a specified time through a pre-designated financial APP or verification platform;
the system requires the user to present an identification document including an ID card, a passport, or a driver's license during the video call, a verifier checks the identity information of the user through the video call, and the verifier automatically recognizes information on the identification document through the OCR technology and matches it with information in the database, including whether facial features are consistent with a photo on the identification document;
the verifier poses some dynamic questions to the user, where the dynamic questions are generated based on account information of the user, including recent transaction details, frequently-used addresses, or registration information; and if the identity information of the user completely matches the information in the database and facial recognition verification is successful, the certification is successful, and the fourth authentication tag is added, allowing the user to continue account operations; or
if the user does not receive the video call request or the user fails to pass the verification, the account is locked or further verification is required.

A method for customer identity authentication in the financial industry includes the following steps.

At S1, a one-time password (OTP), a personal identification number (PIN) code, and security question answer information for user login are collected, a knowledge factor collection dataset is established, and the knowledge factor collection dataset is matched with corresponding values in a database, and if all three items are successfully matched, a first authentication tag is added; or if any item fails to match, a first alert instruction is sent.

At S2, geolocation verification is set up when the user initiates a transaction behavior to obtain a current user geolocation and geofencing status, user historical frequently-used locations are collected, and a location verification index Dzy is constructed, and if the location verification index Dzy is greater than a distance threshold, a second alert instruction is triggered; or if the location verification index is less than or equal to the distance threshold, a second authentication tag is added.

At S3, a user fingerprint is collected to obtain a fingerprint image, user fingerprint-related features are extracted to calculate and obtain a core point region distribution index Hxz and a peripheral region distribution index Wwz, the core point region distribution index Hxz and the peripheral region distribution index Wwz are correlated, and deep computation is performed to obtain a fingerprint factor matching index Zwyz, and if the fingerprint factor matching index Zwyz is below a matching threshold, a third alert instruction is triggered; or if the fingerprint factor matching index Zwyz is greater than or equal to the matching threshold, a third authentication tag is added.

At S4, after the user obtains the first authentication tag, the user is allowed to log into a financial APP to perform inquiry or information retrieval operations; after the user obtains the second authentication tag, the user is allowed to perform a transaction behavior operation, if a collected transaction behavior exceeds CNY 10,000, a pop-up window is triggered to verify the user fingerprint, and after passing the third authentication tag, a high-value transaction operation is allowed, upon receiving the first alert instruction, the second alert instruction, or the third alert instruction, the same verification method is repeatedly performed on the user, and if verification fails three consecutive times, an account is locked and the user is required to provide original identity documents at an offline service counter for reactivation.

At S5, during the user login and transaction processes, user behavior data is collected, a risk prediction model is established and trained, and device-changing login features, transaction volume behavior features, typing habit features, and account modification information features are extracted from the user behavior data to construct an anomalous-behavior index Ycx, and if the anomalous-behavior index Ycx is higher than a behavioral anomaly threshold, a fourth alert instruction is sent.

At S6, upon receiving the fourth alert instruction, a video call is initiated via a management terminal to perform identity verification, and identity information and documents of the user are validated, and upon successful authentication, a fourth authentication tag is added and continued operations are allowed.

The present invention provides a method and system for customer identity authentication in the financial industry, which offer the following beneficial effects.

(1) This system simultaneously collects the OTP, the PIN code, and the security question answer information through the first collection module to form a knowledge factor collection dataset. The combination of the three verification methods significantly improves security, and prevents the risk of single passwords or PIN codes being cracked by hackers. Through a dual authentication tag mechanism involving geolocation verification and fingerprint verification, the authenticity of the user's identity during transactions is ensured, thereby reducing the possibility of identity forgery and illegal transactions. In particular, the introduction of the location verification index Dzy and the fingerprint factor matching index Zwyz further improves the accuracy of verification. The system incorporates a built-in alert mechanism, including a first alert instruction, a second alert instruction, and a third alert instruction. When any verification fails, an alert instruction is immediately sent to prevent unauthorized access and transaction behaviors. If verification fails three consecutive times, the system automatically locks the account, further strengthening security protection.

(2) Through a user behavior recognition module, the system can collect and analyze user behavior data during user login and transaction processes to construct an anomalous-behavior index Ycx. This module can recognize behaviors such as device-changing logins, anomalous transaction volumes, and deviations in typing habits, and upon detecting an anomalous behavior, it sends a fourth alert instruction to effectively prevent fraudulent behaviors. Upon receiving the fourth alert instruction, identity verification is conducted via a video call to validate the identity information and documents of the user. This layer of verification ensures that even in high-risk situations, user identity can be confirmed through face-to-face dynamic verification. The system designs a reasonable multi-layer verification process: after obtaining the respective authentication tags, the user is allowed to perform corresponding operations, such as information inquiry, conducting transaction and high-value transaction operations, thereby optimizing the user experience and avoiding excessive cumbersome steps. By means of the mechanism of locking the account after multiple verification failures and requiring offline reactivation, the system prevents hackers from obtaining user accounts through persistent attacks, thereby safeguarding security of user accounts.

### BRIEF DESCRIPTION OF DRAWINGS

FIG. 1 is a flowchart of the block diagram of a first collection module of the present invention;

FIG. 2 is a flowchart of the block diagram of a system for customer identity authentication in the financial industry according to the present invention; and

FIG. 3 is a schematic diagram of the steps of a method for customer identity authentication in the financial industry according to the present invention.

### DETAILED DESCRIPTION

The technical schemes in the embodiments of the present invention are clearly and completely described in the following with reference to the drawings in the embodiments of the present invention. It is obvious that the described embodiments are only some of the embodiments of the present invention and are not all the embodiments thereof. All other embodiments obtained by those of ordinary skill in the art based on the embodiments of the present invention without inventive effort are within the scope of the present invention.

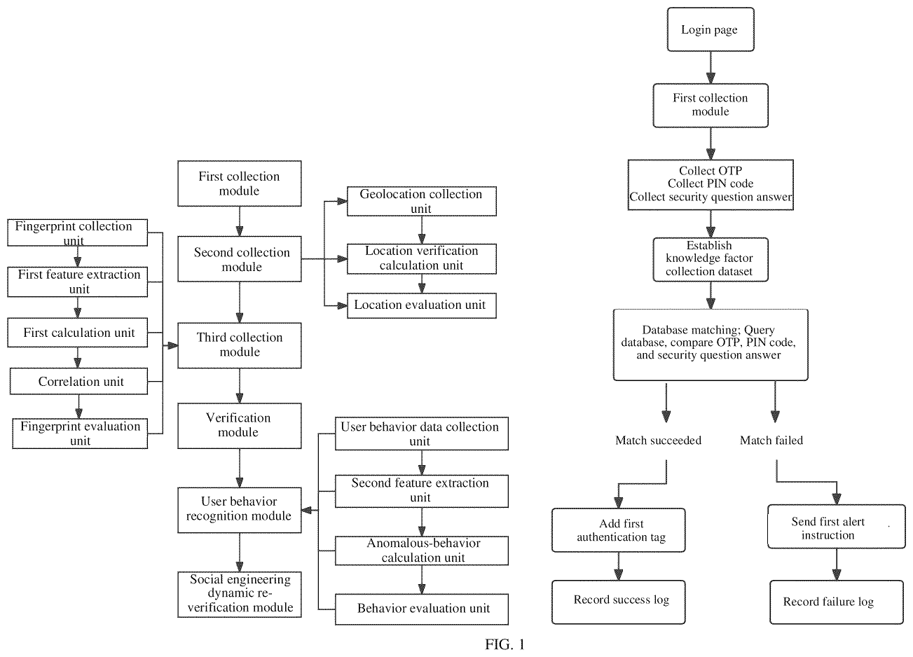

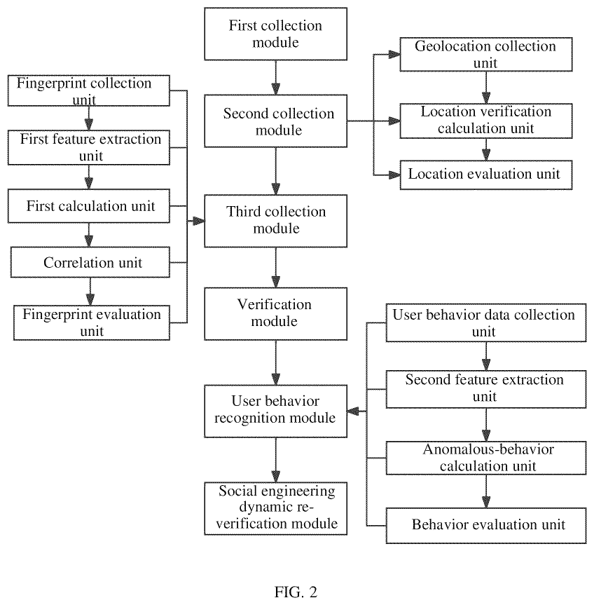

Embodiment 1: with reference to FIGS. 1 and 2, the present invention provides a system for customer identity authentication in the financial industry. The system includes:
a first collection module configured to collect an OTP, a PIN code, and security question answer information for user login, establish a knowledge factor collection dataset, and match the knowledge factor collection dataset with corresponding values in a database, and if all three items are successfully matched, add a first authentication tag, and record a success log; or if any item fails to match, send a first alert instruction, and record a failure log;
a second collection module configured to set up geolocation verification when the user initiates a transaction behavior to obtain a current user geolocation and geofencing status, collect user historical frequently-used locations, and construct a location verification index Dzy, and if the location verification index Dzy is greater than a distance threshold, trigger a second alert instruction; or if the location verification index is less than or equal to the distance threshold, add a second authentication tag;
a third collection module configured to collect a user fingerprint to obtain a fingerprint image, extract user fingerprint-related features to calculate and obtain a core point region distribution index Hxz and a peripheral region distribution index Wwz, correlate the core point region distribution index Hxz and the peripheral region distribution index Wwz, and perform deep computation to obtain a fingerprint factor matching index Zwyz, and if the fingerprint factor matching index Zwyz is below a matching threshold, trigger a third alert instruction; or if the fingerprint factor matching index Zwyz is greater than or equal to the matching threshold, add a third authentication tag;
a verification module configured to, after the user obtains the first authentication tag, allow the user to log into a financial APP to perform inquiry or information retrieval operations; after the user obtains the second authentication tag, allow the user to perform a transaction behavior operation, if a collected transaction behavior exceeds CNY 10,000, trigger a pop-up window to verify the user fingerprint, and after passing the third authentication tag, allow a high-value transaction operation, upon receiving the first alert instruction, the second alert instruction, or the third alert instruction, repeatedly perform the same verification method on the user, and if verification fails three consecutive times, lock an account and require the user to provide original identity documents at an offline service counter for reactivation;
a user behavior recognition module configured to, during the user login and transaction processes, collect user behavior data, establish and train a risk prediction model, and extract device-changing login features, transaction volume behavior features, typing habit features, and account modification information features from the user behavior data to construct an anomalous-behavior index Ycx, and if the anomalous-behavior index Ycx is higher than a behavioral anomaly threshold, send a fourth alert instruction; and
a social engineering dynamic re-verification module configured to, upon receiving the fourth alert instruction, initiate a video call via a management terminal to perform identity verification, and validate identity information and documents of the user, and upon successful authentication, add a fourth authentication tag and allow continued operations.

In this embodiment, this system simultaneously collects the OTP, the PIN code, and the security question answer information through the first collection module to form a knowledge factor collection dataset. The combination of the three verification methods significantly improves security, and prevents the risk of single passwords or PIN codes being cracked by hackers. Through a dual authentication tag mechanism involving geolocation verification and fingerprint verification, the authenticity of the user's identity during transactions is ensured, thereby reducing the possibility of identity forgery and illegal transactions. In particular, the introduction of the location verification index Dzy and the fingerprint factor matching index Zwyz further improves the accuracy of verification. The system incorporates a built-in alert mechanism, including a first alert instruction, a second alert instruction, and a third alert instruction. When any verification fails, an alert instruction is immediately sent to prevent unauthorized access and transaction behaviors. If verification fails three consecutive times, the system automatically locks the account, further strengthening security protection.

Through a user behavior recognition module, the system can collect and analyze user behavior data during user login and transaction processes to construct an anomalous-behavior index Ycx. This module can recognize behaviors such as device-changing logins, anomalous transaction volumes, and deviations in typing habits, and upon detecting an anomalous behavior, it sends a fourth alert instruction to effectively prevent fraudulent behaviors. Upon receiving the fourth alert instruction, identity verification is conducted via a video call to validate the identity information and documents of the user. This layer of verification ensures that even in high-risk situations, user identity can be confirmed through face-to-face dynamic verification. The system designs a reasonable multi-layer verification process: after obtaining the respective authentication tags, the user is allowed to perform corresponding operations, such as information inquiry, conducting transaction and high-value transaction operations, thereby optimizing the user experience and avoiding excessive cumbersome steps. By means of the mechanism of locking the account after multiple verification failures and requiring offline reactivation, the system prevents hackers from obtaining user accounts through persistent attacks, thereby safeguarding security of user accounts.

Embodiment 2: this embodiment is an explanatory description of Embodiment 1. With reference to FIG. 1, specifically, the second collection module includes a geolocation collection unit, a location verification calculation unit, and a location evaluation unit, where
the geolocation collection unit is configured to collect and obtain the current user geolocation through GPS and Internet Protocol (IP)-based geolocation technology, retrieve historical transaction locations, and establish a user frequently-used location database; and it can determine in real time whether the location thereof is correct, thereby effectively preventing the risks of geographically anomalous login and location forgery.

The location verification calculation unit is configured to extract latitude and longitude features of locations from the frequently-used location database, and calculate and obtain the location verification index Dzy through a Haversine formula:

Dzy=2r*a sin(\sqrt{hav(φ₂−φ₁)+cos(φ₁)*cos(φ₂)*hav(λ₂−λ₁)});
where r represents the radius of the Earth, which is set to a value of 6,371 kilometers, φ₁ represents the latitude of a historical location, φ₂ represents the latitude of a current login location, λ₂ represents the longitude of the current login location, λ₁ represents the longitude value of the historical location, hav represents a haversine function; and a sin represents a precision dimension conversion function.represents the precision dimension conversion function. By extracting latitude and longitude features of locations from the user frequently-used location database, and using the Haversine formula, the location verification index Dzy is calculated. This formula takes into account the curvature of the Earth to ensure the accuracy of the calculations, thereby enabling more precise distance evaluation between the current user location and historical transaction locations.

The location evaluation unit is configured to preset a distance threshold, and compare the distance threshold with the location verification index Dzy to obtain a distance evaluation result, including:
if the location verification index Dzy is greater than the distance threshold, it indicates that current user location credibility and geofencing compliance are anomalous with a risk of geographically anomalous login, then the second alert instruction is triggered; or
if the location verification index Dzy is less than or equal to the distance threshold, it indicates that current user location credibility and geofencing compliance are normal without a risk of geographically anomalous login, then the second authentication tag is added.

In this embodiment, through the combination of dynamic location verification and intelligent distance evaluation, the system can effectively identify and prevent location forgery, session hijacking, or other fraudulent behaviors. This comprehensive verification method significantly enhances the security of financial transactions, and reduces potential risks caused by anomalous locations. While ensuring security, the system reduces unnecessary user intervention and verification steps through intelligent verification mechanisms, thereby enhancing user experience. When the user location is normal, the system automatically adds the second authentication tag, enabling the user to smoothly conduct transactions and avoiding excessive interference.

Embodiment 3: this embodiment is an explanatory description of Embodiment 1. With reference to FIG. 1, specifically, the third collection module includes a fingerprint collection unit, a first feature extraction unit, and a first calculation unit, where
the fingerprint collection unit is configured to collect and obtain the user fingerprint image using an online or offline fingerprint collection device, and perform grayscale processing, binarization, and denoising preprocessing operations on the fingerprint image; and
the first feature extraction unit is configured to extract core point region distribution features and peripheral region distribution features from the preprocessed fingerprint image using the Harris corner detection algorithm, and perform in-depth analysis via the first calculation unit based on the core point region distribution features and the peripheral region distribution features, and calculate and obtain the core point region distribution index Hxz and the peripheral region distribution index Wwz through the following formulas:

$$Zwyz = \frac{{\sum }_{i = 1}^{{N}_{h}} {w}_{i} * ( {D}_{i} + {F}_{i} + {S}_{i} + {A}_{i} ) * ( 1 - \frac{{oD}_{h}}{µ {D}_{h}} ) * ( 1 - \frac{o {θ}_{h}}{µ {θ}_{h}} )}{{A}_{h} * ρ h} ;$$

where Nₕ is the number of feature points in the core point region, wᵢ is the weight of an i-th core point, Dᵢ is the distance between the i-th core point and its nearest neighbor core point; Fᵢ is a bifurcation parameter of the i-th core point; Sᵢ is a short ridge parameter of the i-th core point; Aᵢ is an island point parameter of the i-th core point; oDₕ is a standard deviation of distances between all feature points in the core point region; μDₕ is an average value of distances between all feature points in the core point region; oθₕ is a standard deviation of directional angles of all feature points in the core point region; μθₕ is an average value of directional angles of all feature points in the core point region; Aₕ is the area of the core point region; and ρh is a ridge density of the core point region; and

$$Wwz = \frac{{\sum }_{i = 1}^{{N}_{w}} {E}_{i} * ( {C}_{i} + {O}_{i} + {P}_{i} + {R}_{i} ) * ( 1 - \frac{{oD}_{w}}{µ {D}_{w}} ) * ( 1 - \frac{o {θ}_{w}}{µ {θ}_{w}} )}{{A}_{w} * ρ w} ;$$

where N_{w} is the number of feature points in the peripheral region, Eᵢ is the weight of an i-th peripheral feature point, C₁ is the distance between the i-th peripheral feature point and its nearest neighbor peripheral feature point; Oᵢ is a bifurcation parameter of the i-th peripheral feature point; Pᵢ is a short ridge parameter of the i-th peripheral feature point; R; is an island point parameter of the i-th peripheral feature point; oD_{w} is a standard deviation of distances between all feature points in the peripheral region; μD_{w} is an average value of distances between all feature points in the peripheral region; oθ_{w} is a standard deviation of directional angles of all feature points in the peripheral region; μθ_{w} is an average value of directional angles of all feature points in the peripheral region; A_{w} is the area of the peripheral region; and ρw is a ridge density of the peripheral region.

The third collection module further includes a correlation unit and a fingerprint evaluation unit, where
the correlation unit is configured to calculate and obtain the fingerprint factor matching index Zwyz based on the core point region distribution index Hxz and the peripheral region distribution index Wwz through the following correlation formula:

Zwyz=Hxz*α+Wwz*β;
where α and β represent weight coefficients of the core point region distribution index Hxz and the peripheral region distribution index Wwz, respectively, and α+β=1.

The fingerprint evaluation unit is configured to construct a matching threshold based on an initial fingerprint recorded by a user in a database and compare the matching threshold with the fingerprint factor matching index Zwyz to obtain a fingerprint matching evaluation result, including:
if the fingerprint factor matching index Zwyz is greater than or equal to the matching threshold, it indicates that a current user fingerprint matching degree is qualified and indicates an operation by the user themselves, the third authentication tag is added; or
if the fingerprint factor matching index Zwyz is less than the matching threshold, it indicates that the current user fingerprint matching degree is anomalous with a risk of unauthorized use, then the third alert instruction is triggered.

In this embodiment, through precise fingerprint image processing and analysis, the third collection module uses the Harris corner detection algorithm to extract and evaluate the distribution features of core points and peripheral regions. Such detailed feature extraction and matching algorithms help improve the accuracy of fingerprint authentication and reduce the risk of misrecognition. By comparing these features with the initial fingerprint data in the database, the system can effectively identify user identity, thereby enhancing the security of financial transactions.

Embodiment 4: this embodiment is an explanatory description of Embodiment 1. With reference to FIG. 1. Specifically, the user behavior recognition module includes a user behavior data collection unit, a second feature extraction unit, and an anomalous-behavior calculation unit, where
the user behavior data collection unit is configured to record device information used during the user login, including device type, operating system, browser type, and device ID; record transaction behavior data of the user, including transaction amount, transaction frequency, and transaction time; record a typing speed, a keystroke error rate, and a keystroke rhythm of the user; and record modification behaviors by the user on account information, including password modification, contact information modification, and bound device modification;
the second feature extraction unit is configured to, after establishing and training the risk prediction model using machine learning algorithms including logistic regression, decision tree, or random forest, extract the device-changing login features, the transaction volume behavior features, the typing habit features, and the account modification information features from the user behavior data; and
the anomalous-behavior calculation unit is configured to calculate the anomalous-behavior index Ycx of the user in real-time based on the risk prediction model, where the anomalous-behavior index Ycx is calculated and obtained through the following formula:

$$Ycx = \frac{{E}_{f} * {a}_{1} + {T}_{f} * {a}_{2} + {A}_{f} * {a}_{3}}{{a}_{1} + {a}_{2} + {a}_{3}} + ( \frac{{K}_{s}}{{K}_{e}} ) * {a}_{4} + {C}_{1} ;$$

where E_{f} is the value of frequency of device changing by the user, T_{f} is a daily transaction frequency value, A_{f} is a user change frequency value, Kₛ is a typing speed per minute of the user, Kₑ represents an error rate per minute, a₁ [symbol] a₂ [symbol] a₃ and a₄ are all weight coefficients, and C₁ represents a first correction constant.

Specifically, the user behavior recognition module further includes a behavior evaluation unit, where
the behavior evaluation unit is configured to preset the behavioral anomaly threshold and compare the behavioral anomaly threshold with the anomalous-behavior index Ycx for evaluation to obtain a user behavior evaluation result, including:
if the anomalous-behavior index Ycx is greater than the behavioral anomaly threshold, it indicates that an operational behavior of the user has risks, then the fourth alert instruction is sent; or if the anomalous-behavior index Ycx is less than or equal to the behavioral anomaly threshold, it indicates that an operational behavior of the user has no risks.

In this embodiment, the user behavior recognition module enhances the ability of the financial system to monitor user identity and behavior through a data-driven approach, making the identity authentication procedure safer and more reliable; and the system can adjust risk evaluation based on the anomalous-behavior index Ycx of the user behavior, thereby providing dynamic security protection and reducing the risk of fraud and the risk of unauthorized use of the account.

Embodiment 5: this embodiment is an explanatory description of Embodiment 1. With reference to FIG. 1, specifically, the steps executed by the social engineering dynamic re-verification module are as follows:
upon receiving the fourth alert instruction, the system sends a video call request to the user, requiring the user to undergo identity verification through a video call, with content of the request including a video call link and a verification time window;
the user accepts the video call request within a specified time through a pre-designated financial APP or verification platform;
the system requires the user to present an identification document including an ID card, a passport, or a driver's license during the video call, a verifier checks the identity information of the user through the video call, and the verifier automatically recognizes information on the identification document through the OCR technology and matches it with information in the database, including whether facial features are consistent with a photo on the identification document;
the verifier poses some dynamic questions to the user, where the dynamic questions are generated based on account information of the user, including recent transaction details, frequently-used addresses, or registration information; and if the identity information of the user completely matches the information in the database and facial recognition verification is successful, the certification is successful, and the fourth authentication tag is added, allowing the user to continue account operations; or
if the user does not receive the video call request or the user fails to pass the verification, the account is locked or further verification is required.

In this embodiment, upon receiving the fourth alert instruction, the system sends a video call request including a link and a verification time window to the user, ensuring that the user can undergo identity verification within the specified time. This process enhances the security and timeliness of the verification. During the video call, the user is required to present an identification document (such as an ID card, a passport, or a driver's license), and a verifier automatically recognizes the document information through the OCR technology. This step ensures that the identity information of the user matches the information in the database, thereby reducing the risk of identity spoofing. The verifier checks whether the facial features of the user are consistent with the photo on the identification document through the video call, further enhancing the accuracy and security of identity verification. The verifier poses dynamic questions generated based on account information, such as recent transaction details, frequently-used addresses, or registration information. Through the user's responses to the dynamic questions, the true identity of the user can be further confirmed. If the user identity information completely matches and facial recognition verification is successful, the system will add a fourth authentication tag, allowing the user to continue account operations. Otherwise, the system will lock the account or require further verification. This mechanism effectively protects account security and can quickly cope with potential security threats.

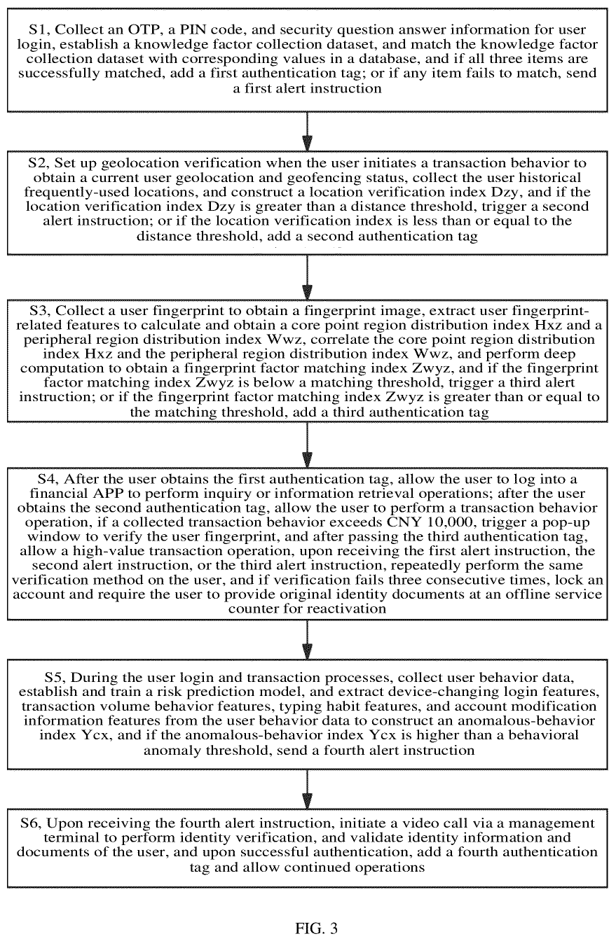

Embodiment 6: with reference to FIG. 3, a method for customer identity authentication in the financial industry includes the following steps.

At S1, a one-time password (OTP), a personal identification number (PIN) code, and security question answer information for user login are collected, a knowledge factor collection dataset is established, and the knowledge factor collection dataset is matched with corresponding values in a database, and if all three items are successfully matched, a first authentication tag is added; or if any item fails to match, a first alert instruction is sent.

At S2, geolocation verification is set up when the user initiates a transaction behavior to obtain a current user geolocation and geofencing status, user historical frequently-used locations are collected, and a location verification index Dzy is constructed, and if the location verification index Dzy is greater than a distance threshold, a second alert instruction is triggered; or if the location verification index is less than or equal to the distance threshold, a second authentication tag is added.

At S3, a user fingerprint is collected to obtain a fingerprint image, user fingerprint-related features are extracted to calculate and obtain a core point region distribution index Hxz and a peripheral region distribution index Wwz, the core point region distribution index Hxz and the peripheral region distribution index Wwz are correlated, and deep computation is performed to obtain a fingerprint factor matching index Zwyz, and if the fingerprint factor matching index Zwyz is below a matching threshold, a third alert instruction is triggered; or if the fingerprint factor matching index Zwyz is greater than or equal to the matching threshold, a third authentication tag is added.

At S4, after the user obtains the first authentication tag, the user is allowed to log into a financial APP to perform inquiry or information retrieval operations; after the user obtains the second authentication tag, the user is allowed to perform a transaction behavior operation, if a collected transaction behavior exceeds CNY 10,000, a pop-up window is triggered to verify the user fingerprint, and after passing the third authentication tag, a high-value transaction operation is allowed, upon receiving the first alert instruction, the second alert instruction, or the third alert instruction, the same verification method is repeatedly performed on the user, and if verification fails three consecutive times, an account is locked and the user is required to provide original identity documents at an offline service counter for reactivation.

At S5, during the user login and transaction processes, user behavior data is collected, a risk prediction model is established and trained, and device-changing login features, transaction volume behavior features, typing habit features, and account modification information features are extracted from the user behavior data to construct an anomalous-behavior index Ycx, and if the anomalous-behavior index Ycx is higher than a behavioral anomaly threshold, a fourth alert instruction is sent.

At S6, upon receiving the fourth alert instruction, a video call is initiated via a management terminal to perform identity verification, and identity information and documents of the user are validated, and upon successful authentication, a fourth authentication tag is added and continued operations are allowed.

In this embodiment, the method of the present invention effectively improves the security of accounts and transactions through multi-layered security protection. First, preliminary authentication is performed by collecting a one-time password (OTP), a personal identification number (PIN) code, and a security question answer, ensuring that the user passes basic identity verification during the login phase. Second, geolocation verification is performed to check the match between the current user location and historical frequently-used locations, preventing the risk of geographically anomalous login. Fingerprint recognition technology further ensures the authenticity of the user identity by analyzing features of core points and peripheral regions. Upon detecting an anomalous behavior, such as a high transaction amount or an anomalous device login, the system triggers an alert and requires additional verification, thereby mitigating the risk of fraud. For a high-value transaction, the system initiates a pop-up window to verify the user fingerprint and performs further verification in case of a fingerprint authentication failure, thereby ensuring transaction security. Additionally, social engineering verification validates the user identity through a video call, adding an extra layer of security. The method as a whole provides a comprehensive and effective account protection mechanism through integrated application of authentication, alerting, behavior analysis, and social engineering verification, thereby significantly enhancing the security of financial transactions.

The values of the thresholds are set to facilitate comparative analysis, and determining the values of the thresholds depends on the amount of sample data and the baseline quantity set by those of skill in the art for each group of sample data, provided that the proportional relationship between parameters and quantified values remains unaffected.

The above formulas are derived from collecting a large amount of data for software simulation and selecting a formula that approximates real-world values, with coefficients in the formula set by those of skill in the art based on actual conditions. The foregoing represents only preferred specific implementations of the present invention, but the scope of protection of the present invention is not limited to this. Any equivalent replacements or modifications made by any technician familiar with this technical field within the technical scope disclosed in the present invention, based on its technical solutions and inventive concepts, shall fall within the claimed scope of protection.

1. A method for customer identity authentication in the financial industry, comprising:
collecting a one-time password (OTP), a personal identification number (PIN) code, and a security question answer information for user login associated with a user;
establishing a knowledge factor collection dataset;
comparing the knowledge factor collection dataset with corresponding values in a database;
generating a first authentication tag in response to the collected information being successfully matched;
permitting the user login based on the first authentication tag,
in response to identifying a transaction associated with the user, obtaining a current user geolocation;
retrieving historical frequently-used locations of the user;
calculating a location verification index based on a distance between the current user geolocation and the historical frequently-used locations using a Haversine-based distance computation;
generating a second authentication tag in response to the location verification index satisfying a preset distance threshold;
in response to determining that the transaction is a high-value transaction, preprocessing a fingerprint image of the user by grayscale processing, binarization, and denoising;
extracting core-region distribution features and peripheral-region distribution features of the fingerprint image using a corner detection algorithm;
calculating a core-point region distribution index and a peripheral-region distribution index based on spatial distribution characteristics of feature points;
determining a fingerprint factor matching index based on a correlation between the core-point region distribution index and the peripheral-region distribution index;
generating a third authentication tag in response to the fingerprint factor matching index satisfying a matching threshold;
permitting operation of the transaction based on the second authentication tag and the third authentication tag;
collecting user behavior data during operations of the user login and the transaction;
extracting behavior features including device-changing login features, transaction volume behavior features, typing habit features, and account modification information features;
constructing an anomalous-behavior index based on the behavior features;
triggering a re-verification operation in response to the anomalous-behavior index being higher than a behavioral anomaly threshold; initiating a video-based identity verification procedure in response to the re-verification operation;
requiring presentation of an identification document;
performing document information recognition using Optical Character Recognition (OCR);
generating a fourth authentication tag upon successful verification; and
permitting continued operations of the user login and the transaction based on the fourth authentication tag.

2. The method according to claim 1, wherein the retrieving of the historical frequently-used locations of the user comprises: retrieving latitude and longitude features of the historical frequently-used locations; and
wherein the calculating of the location verification index based on the distance between the current user geolocation and the historical frequently-used locations using the Haversine-based distance computation comprises: calculating the location verification index using through a Haversine formula based on a spherical distance between the current user geolocation and each historical location,
wherein the Haversine formula incorporates an Earth radius parameter and angular coordinate conversion.

3. The method according to claim 2, further comprising:
comparing the location verification index with the preset distance threshold; and
generating the second authentication tag in response to the location verification index being less than or equal to the preset distance threshold or triggering an alert instruction in response to the location verification index exceeding the preset distance threshold.

4. The method according to claim 1, further comprises:
performing grayscale processing, binarization, and denoising preprocessing operations on the fingerprint image prior to feature extraction.

5. The method according to claim 1, wherein the core-region distribution index is calculated based on a number of feature points in a core region, spatial distances between neighboring feature points, directional distribution parameters, ridge density, and region area; and
wherein the peripheral-region distribution index is calculated based on a number of feature points in a peripheral region, spatial distances between neighboring feature points, directional distribution parameters, ridge density, and region area.

6. The method according to claim 5, wherein the fingerprint factor matching index is calculated by applying weight coefficients to the core-region distribution index and the peripheral-region distribution index to determine a correlated matching value.

7. The method according to claim 1, further comprises:
recording device information comprising device type, operating system, browser type, and device identification;
recording transaction behavior data comprising transaction amount, transaction frequency, and transaction time;
recording typing characteristics comprising typing speed, keystroke error rate, and keystroke rhythm; and
recording account modification behaviors comprising password modification, contact information modification, and bound device modification.

8. The method according to claim 1, wherein the anomalous-behavior index is calculated based on weighted combinations of: a device-changing frequency value, a transaction frequency value, an account modification frequency value, a typing speed value, and a keystroke error rate value.

9. The method according to claim 1, wherein the video-based identity verification procedure further comprises:
performing facial feature comparison with a stored identity image.

10. (canceled)
